(19) United States
(12) Patent Application Publication
(10) Pub. No.: US 2025/0205998 A1
(43) Pub. Date: Jun. 26, 2025

(54) METHOD FOR PRODUCING A LAMINATING COMPONENT OR A HOLOGRAM COMPONENT FOR PRODUCING A COMPOSITE GLASS, AND CORRESPONDING LAMINATING COMPONENTS, HOLOGRAM COMPONENTS, AND COMPOSITE GLASSES

(71) Applicant: Carl Zeiss Jena GmbH, Jena (DE)

(72) Inventors: Martin THOM, Jena (DE); Annett HARTMANN, Jena (DE); Stefan SCHWEDAT, Jena (DE); Christoph ERLER, Jena (DE)

(73) Assignee: Carl Zeiss Jena GmbH, Jena (DE)

(21) Appl. No.: 18/852,011

(22) PCT Filed: Mar. 23, 2023
(86) PCT No.: PCT/EP2023/057466

§ 371 Date: Sep. 27, 2024

(30) Foreign Application Priority Data
Mar. 28, 2022 (DE) 10 2022 107 225.8

(51) Int. Cl. B32B 17/10; B32B 1/00; B32B 7/12; B32B 38/00; G03H 1/02

(52) U.S. Cl. CPC B32B 17/10036; B32B 1/00; B32B 7/12; B32B 17/10431; B32B 17/10788; B32B 17/10935; B32B 38/0012; G03H 1/0252; B32B 2307/412; B32B 2307/7376

(57) ABSTRACT

The invention relates to a method for producing a laminating component or a hologram component. A holographic material, such as a holographic film, is connected either to a laminating agent in order to form a laminating component or to a transparent reinforcing material in order to form a hologram component In order to produce a composite glass, the laminating component or the hologram component can then be laminated between two glass panes, which can be curved in particular. By virtue of the laminating agent of the laminating component or the reinforcing material of the hologram component, damage to the hologram imprinted in the holographic material can be prevented or reduced.

### FIELD OF THE INVENTION

The present application relates to methods of producing lamination components that are then usable for lamination of glass panes for the purpose of producing a composite glass, and of production of hologram components that can likewise be used in composite glass production. In addition, the present application relates to corresponding lamination components, hologram components and composite glasses.

### BACKGROUND OF THE INVENTION

Composite glasses, meaning glasses in which multiple individual glass panes are joined, are used for various applications, for example for safety glass in the automotive sector. The production of such a composite glass can be accomplished, for example, in an autoclave, i.e. by thermal treatment under pressure. Especially for production of composite safety glass, this involves placing one or more polymer films between two or more glass panes and baking them in an autoclave to give a unified composite. It is also possible for the glass panes to be curved here in order to create a composite glass having a desired curved freeform as required for automotive applications for example. For instance, windshields typically have a curved shape. A curved freeform, also referred to as a 2D-curved form, in the context of this application refers to surface shapes that cannot be converted to a flat shape by unwinding, for example the surfaces of spheres or ellipsoids.

For various applications, it is desirable to incorporate holograms into such composite glass panes. For example, such holograms can be used for data projection, as described, for example, in WO2016/146697 A1. Such holograms are provided in many cases as hologram films, in which a hologram is provided in the form of exposed photosensitive material on a carrier film or between two carrier films.

If such conventional hologram films are inserted between the glass panes for the autoclave process, the problem arises that the hologram films are greatly softened when heated in the autoclave and can slide especially as a result of shear stresses that arise from the curvature of the panes, which results in creasing of the hologram films. This destroys the optical function of the holograms. Similar behavior is found when the composite glass is produced by loose laying of the different materials, for example in a layer stack of glass laminant such as polyvinylbutyral (PVD) or ethylene-vinyl acetate (EVA)-hologram film-laminant-glass.

An alternative approach is described in DE 10 2019 130 022 A1 or DE 10 2020 112 447 A1. Here, individual panes that are to be holographically functionalized for a composite pane to be produced are first coated with an unexposed photopolymer, for example in liquid form. This is followed by exposure by means of a contact copy with a master hologram, followed by fixing (curing) of the exposed photopolymer. Only then does the production of the composite glass take place. Although this method solves the above-described problem of creasing of hologram films, it is very complex with regard to the exposure technology, such that implementation for mass production will be correspondingly costly.

It is therefore an object of the present application to provide improved means of production of composite glasses with incorporated holograms.

### SUMMARY OF THE INVENTION

A method of producing a lamination component as claimed in claim 1, a method of producing a hologram component as claimed in claim 14, a lamination component as claimed in claim 18, a hologram component as claimed in claim 20, a method of producing a composite glass as claimed in claim 22, and a composite glass as claimed in claim 28 or 29 are provided. The dependent claims define further embodiments.

In a first aspect, a method of producing a lamination component for bonding of two glass panes is provided, comprising:
providing a laminant, and
bonding the laminant to a holographic material.

The lamination component thus produces an intermediate that firstly contains a holographic material and secondly a laminant. In a later lamination process, the laminant serves firstly for lamination, and secondly for stabilization or stiffening of the holographic material, and can at least partly prevent creasing of or other damage to the hologram in the lamination process in the production of a composite glass.

A laminant generally means a substance that can establish a bond between two glass panes in a lamination process, for example in an autoclave. Such laminants may, for example, be thermoplastics such as polyvinylbutyral (PVB), ethylene-vinyl acetate or corresponding copolymers thereof.

In one variant, the holographic material is a hologram film, in which case the providing of the laminant and the bonding of the laminant to the holographic material comprises applying the laminant to at least one side, preferably to two opposite sides, of the hologram film. Such application may comprise, for example, application by extrusion. In this way, as it were, a layer system composed of laminant and hologram film is then produced, where the laminant can in turn stabilize the hologram film material on application.

A hologram film is generally a film comprising a carrier material and an exposed or unexposed photosensitive material on the carrier material or between two layers of carrier material. For example, the carrier material may include a thermoplastic such as acrylic glass (PMMA) or polycarbonate (PC) having layer thicknesses between 50 and 150 μm and photopolymer as photosensitive material having layer thicknesses between 10 and 100 μm, where these values should be considered merely as an example and it is also possible to use other conventional hologram films. Overall, hologram films typically have a thickness between 20 and 500 μm.

In the case that the laminant is applied to two opposite sides of the hologram film, the thickness of the laminant on a first side of the two opposite sides may be at least 1.25 times, for example at least 1.5 times, a thickness of the laminant on a second side of the two opposite sides. As will be elucidated further down, such a lamination component, when it is appropriately oriented between two glass panes that are curved or are to be curved, is advantageous in order to absorb stresses.

The holographic material may comprise a hologram, i.e. may already have an exposed hologram, or else may be a photosensitive material into which a hologram can be exposed later on. For instance, it is especially possible to provide a lamination component with a ready-exposed hologram.

In another alternative, the bonding of the laminant to the holographic material comprises introducing a photosensitive material into the laminant. The chemical composition of the laminant is thus extended here such that it comprises a photosensitive material. For this purpose, for example, it is possible to add crosslinkable monomers, initiators, dye systems and coinitiators or generally light-curing chemicals, as described in EP1438634 B1 for example, during the production of the laminant, for example as film, as additives. The laminant may, as above, be polyvinylbutyral, ethylene-vinyl acetate or a copolymer thereof. The result is thus a film composed of the laminant, which is simultaneously exposable with a hologram. The lamination component thus produced is then first stored in the dark before a hologram is then exposed, for example by a conventional replication process using a master hologram. After the holograms have been exposed, the material is fixed by bleaching or a thermal aftertreatment, i.e. cured.

In yet another embodiment, a multilayer system of laminant and photosensitive material is produced directly, for example by coextrusion. For example, in this way, a film stack is produced in which a photopolymer as in the above-described EP1438634 B1 is provided between two layers of polyvinylbutyral, ethylene-vinyl acetate or copolymers thereof. The result is thus an exposable film stack which can then, as described above, be subjected to exposure with subsequent fixing.

In a second aspect, a method of producing a hologram component is described, comprising:
providing a hologram film, and
bonding the hologram film to a transparent stiffening material having a thickness between 0.5 mm and 5 mm.

This transparent stiffening material may comprise, for example, polymer types such as some thermoplastics, some polyvinylchloride types, crosslinked epoxy resins or polyester resins, nylon (PA) 6-3T, polycarbonate, polyetherimide, polyether sulfone, polyethylene terephthalate (PET) with nucleation additives, acrylic glass (PMMA), polysulfone, polystyrene, or styrene-acrylonitrile copolymer. The hologram film may be applied to or sunk into the transparent stiffening material by means of an appropriate adhesive (OCA, optically clear adhesive). The polymers are preferably amorphous polymers, and are preferably thermoplastic or have a softening point, but no melting point, in the region of the process temperatures for the later production of composite glass panes (especially in an autoclave). The transparent stiffening material thus becomes “doughy” in a later lamination process and can bend and adjust to the shape of the glass, but without melting. In this way, it is again possible to prevent creasing of the hologram films since the transparent stiffening material serves for stabilization. The hologram film may also be provided with a transparent stiffening material on both sides.

It is possible here for the method of producing the lamination component according to the first aspect or the hologram component according to the second aspect to be configured to provide a lamination component or hologram component which has the effect that, in a later use, described below, for production of a curved composite glass in particular, holographic material or hologram film is present in what is called the neutral fiber of the composite pane, which is curved in particular. The neutral fiber in a curved body is present where the body material—in this case preferably the hologram film—is neither compressed nor stretched on bending. This can be accomplished, for example, by appropriate choice of thicknesses of the laminant, especially on both sides of the holographic material as described above, or of the stiffening material.

A corresponding lamination component which is produced, for example, by the method according to the first aspect is provided according to a third aspect. Such a lamination component for bonding of two glass panes comprises a laminant and a holographic material as described above. All variants described above for the production method may also be applied correspondingly to the lamination component, meaning that the laminant may, for example, be disposed on one or both sides of the holographic material, or the laminant may be admixed with a photosensitive material which is then exposed.

In addition, in accordance with the above method of producing a hologram component according to a fourth aspect, a corresponding hologram component is provided, i.e. a hologram component comprising a hologram film and a transparent stiffening material which is bonded to the hologram film and has a thickness between 0.5 mm and 5 mm. Here too, the various features and variants of the above-described production process are also applicable to the hologram component.

In a fifth aspect, a method of producing a composite glass is provided, comprising:
positioning a component selected from the group consisting of the lamination component as described above and the hologram component as described above between a first glass pane and a second glass pane, and laminating the first glass pane to the second glass pane.

When the component is the lamination component, the laminating can be effected by heating the laminant of the lamination component. When the component is the hologram component, it is additionally possible to position a laminant between the hologram component and the first and second glass panes.

The laminating may especially be effected in an autoclave.

The composite glass which is produced may have a curved target geometry (i.e. geometry after production). The curving may be effected, for example, in the course of heating in the autoclave.

It is possible here in particular for the component to be a lamination component as mentioned above, in which a laminant on a first side is thinner than on a second side. In this case, the positioning may be effected such that the first side of the lamination component adjoins a side of the first glass pane that has or is to have concave curvature, and the second side of lamination component adjoins a side of the second glass pane that has or is to have convex curvature. This can distribute shear stresses that occur such that the holographic material is disrupted, for example creased, to a minor degree during the lamination process.

In addition, a corresponding composite glass is provided, which has a first glass pane, a second glass pane laminated onto the first glass pane, and a hologram component as described above, positioned between the first glass pane and the second glass pane, i.e. a hologram component having a hologram film and a transparent stiffening material bonded to the hologram film as elucidated above. In addition, a composite glass is also provided, comprising: a first glass pane, a second glass pane laminated onto the first glass pane, and a lamination component (20, 28, 40) positioned between the first glass pane and the second glass pane, comprising: a laminant, and a holographic material bonded to the laminant. These composite glasses may especially be curved. The hologram component or the lamination component of the composite glass may be produced or configured as elucidated above.

### BRIEF DESCRIPTION OF THE DRAWINGS

For further elucidation, various embodiments are elucidated in detail hereinafter with reference to the appended drawings. The figures show:

FIG. 1: a flow diagram for illustration of methods according to various embodiments,

FIGS. 2A and 2B: diagrams for illustration of methods and components of various embodiments,

FIG. 3: a diagram for illustration of the distribution of stresses in some embodiments,

FIG. 4: a lamination component according to one embodiment,

FIG. 5: a composite glass according to one embodiment, and

FIGS. 6A and 6B: diagrams for illustration of sinking or application of a hologram film into or onto a carrier material.

### DETAILED DESCRIPTION OF THE INVENTION

There follows a detailed description of various embodiments. This description serves merely for illustration and should not be interpreted as being restrictive.

The same reference numerals in different embodiments mean identical or corresponding components that are not described in detail repeatedly. Variations, modifications and details that are described for one of the embodiments are also applicable to other embodiments, unless stated otherwise.

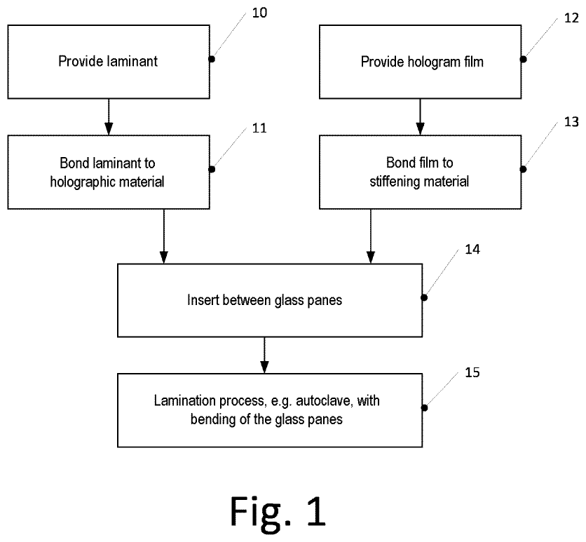

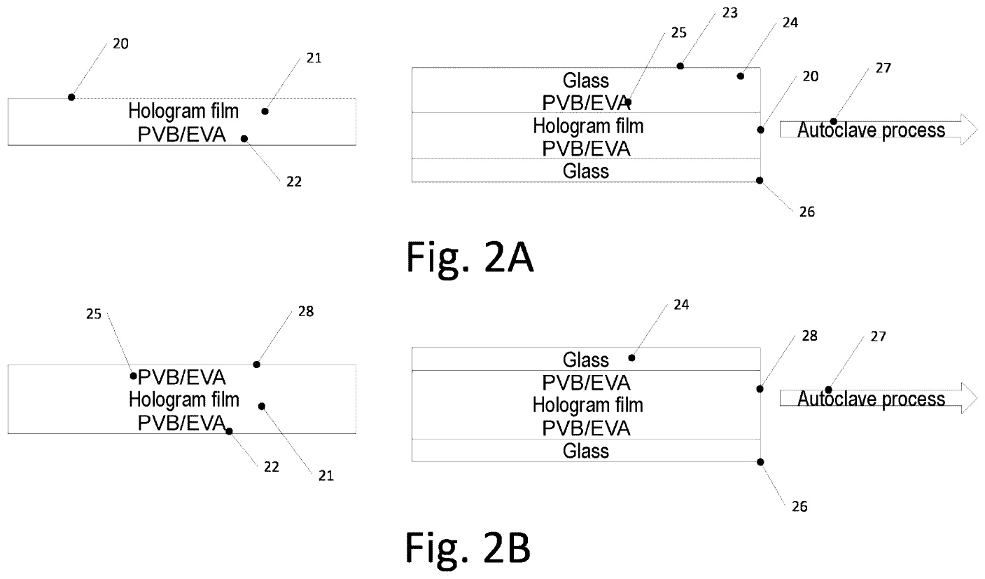

FIG. 1 shows an overall method according to various embodiments, including a method of producing a lamination component, a method of producing a hologram component and a method of producing a composite glass using the lamination component or hologram component. The lamination component or hologram component can be produced separately from the composite glass, for example at a different site or by a different company. FIGS. 2 to 6 further illustrate the method of FIG. 1 and show corresponding lamination components, hologram components and composite glasses inter alia.

In a first alternative of FIG. 1, in step 10, a laminant is provided. As already elucidated above, a laminant is a material which is positioned between two glass panes for production of composite glass, with production of the composite glass by subsequent heating. As already elucidated, the laminant may comprise polyvinylbutyral (PVB), ethylene-vinyl acetate (EVA) or copolymers thereof.

In step 11, the laminant is then bonded to a holographic material. The holographic material may, for example, be a hologram film which, as already elucidated above, may be formed as a layer stack, for example a layer stack composed of 100 μm of polycarbonate followed by 20 μm of a photopolymer followed by 125 μm of polycarbonate, or 60 μm of acrylic glass film (PMMA) followed by 80 μm photopolymer followed by 60 μm of PMMA film, to give just two examples. In the embodiments described here, the thickness of the hologram films may be between 10 and 500 μm. The product of the thickness of the layer suitable for holography (photopolymer) of the hologram film in μm and the achievable refractive index AN as a result of exposure of the photopolymer may be in the range from 0.1 to 0.9. This value may be achieved via a thicker photopolymer or via a greater jump in refractive index.

A hologram may be exposed into the hologram film, especially the photopolymer. The result of steps 10 and 11 is a lamination component which is then inserted between two glass panes in step 14, and these are then laminated in step 15 in a lamination process, for example in an autoclave. It is possible here for the glass panes to be curved in order to produce a composite glass having a desired curved shape.

Examples of this process will now be elucidated with reference to FIG. 2 (including sub FIGS. 2A and 2B), 3 and 4.

In the example of FIG. 2A, steps 10 and 11 of FIG. 1 are implemented by extruding a layer 22 of the laminant (PVB, EVA or a copolymer thereof here) onto a hologram film 21. This results in a lamination component 20. This lamination component is then inserted between a first glass pane 24 and a second glass pane 26, where the first glass pane 24 is likewise provided with a laminant (PVB and/or EVA) 25 in order to form a block 23, and where the laminant 22 faces the lamination component 20 of the second glass pane 26. This stack is then, as indicated by an arrow 27, laminated to form a composite glass in an autoclave process. The thickness of the layers of laminant 22, 25 (PVB/EVA films) may be between 125 and 600 μm, and the glass panes may have a thickness of up to 3 mm or higher, up to 2 mm or up to 1 mm. This is also applicable to the embodiments of FIG. 2B and 3-6 described further down, unless stated otherwise.

Because the hologram film 21 is first provided with the laminant 22 in a separate step, the laminant 22 can stabilize the hologram film 21 during the autoclave process, for example in that it absorbs the tensions that arise in the bending of the glass panes 24, 26.

FIG. 2B shows a variant of FIG. 2A. Here, in addition, the laminant 25, which is bonded as a separate film or to glass 24 in the case of FIG. 2A, is likewise extruded onto the hologram film 21 on the second side of the hologram film 21 in order to form a lamination component 28. This lamination component 28 is then disposed between the first glass pane 24 and the second glass pane 26 and is laminated in an autoclave process, again indicated by arrow 27, to form a composite glass.

The thickness of the laminant 22 in FIG. 2A or the thicknesses of laminants 22, 25 in FIG. 2B that are applied to the hologram film 21 may be guided by the intended curvature of the glass panes 24, 26. The hologram film 21 may especially have an already exposed hologram. The distortions to which the hologram film 21 is subject in the autoclave process are then minimal if the hologram film is present in what is called the neutral fiber of the bent layer composite. The neutral fiber in a curved body is present where the body material—in this case preferably the hologram film—is neither compressed nor stretched on bending.

In one embodiment, the thicknesses of the laminants 22, 55 are different. It is preferable here to provide that side of the hologram film 21 which adjoins a concave-curved side of the glass in the later composite glass with a thicker layer of the laminant, while the side of the hologram film that adjoins a convex-curved side of the glass in the composite glass is equipped with a thinner film (for example about 1 mm).

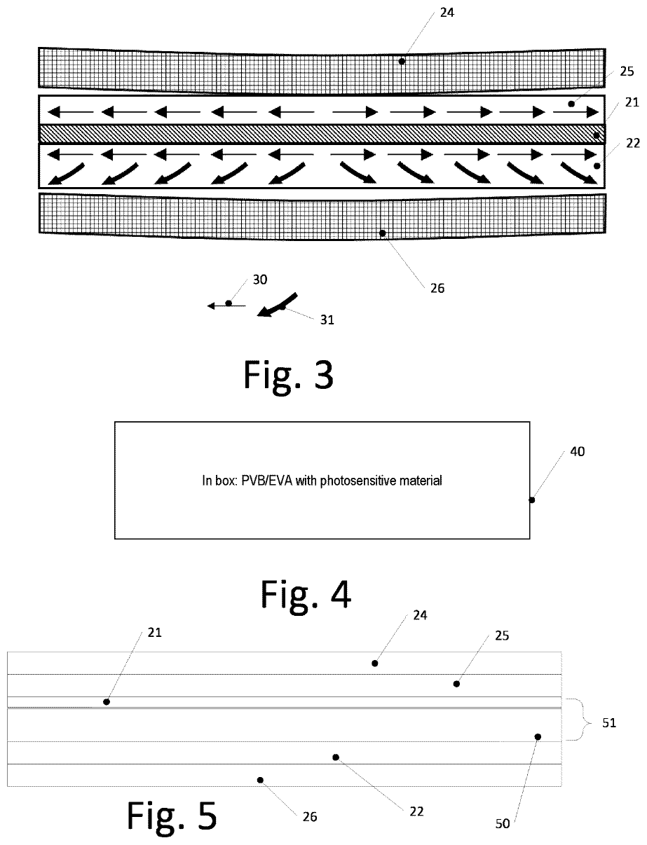

This is illustrated with reference to FIG. 3. The layer of the laminant 22 adjoins the concave-curved glass side of the glass pane 26 here, while the layer of the laminant 25 adjoins a convex-curved side of the glass pane 24. The layer of the laminant 22 is therefore thicker than the layer of laminant 25, for example at least 1.25 times thicker or 1.5 times thicker. In the autoclave process, the layers of laminants 22, 25 become doughy, and hence the laminant 22 is able to efficiently absorb and compensate for the shear stress associated with the increasing deformation of the glass panes. In other words, the hologram film 21 is pressed more uniformly against the convex-curved side of the glass pane 24 by virtue of a uniform pressure of the thicker laminant 22. Thick arrows 31 in the laminant 22 indicate that this is able to efficiently follow the shear direction/shear stress, while thinner arrows 30 indicate that the respective parts are less able to follow the shear direction. Thus, the laminant adjacent to the hologram film 21 is less significantly affected, and hence the hologram film itself as well. In this way, it is possible to reduce creasing of the hologram film.

After laminants have been extruded onto a hologram film, there are further means of producing the lamination component according to steps 10 and 11. In one alternative, a layer stack as for the lamination component 20 of FIG. 2A or 28 of FIG. 2D, rather than by extrusion of the laminant onto the hologram film, is also produced by coextrusion of laminants together with photosensitive material, meaning that only photosensitive material is coextruded together with laminant rather than the hologram film 21 in FIGS. 2A and 2B. The laminant here then also fulfills the function of the carrier film in conventional hologram films. As already elucidated at the outset, such a coextrudate must then be correspondingly exposed.

In another variant shown in FIG. 4, photosensitive material, i.e. light-curing chemicals, for example as described in EP1438634B1, are mixed in as additive during the production of the laminant. This results in a film composed of laminant, which is additionally photosensitive and can be exposed with appropriate hologram structures. The exposure is then followed by fixing in a conventional manner. The lamination component thus formed can then likewise be used as described above in an autoclave for production of a curved composite glass in particular.

In this variant of FIG. 1, comprising steps 10 and 11, a laminant is bonded to holographic material in order to form a lamination component. The laminant effectively stabilizes the holographic material. In a second approach, which is now described again with reference to FIG. 1, a hologram film is provided with a stiffening material before being laminated between two glass panes.

Thus, the second approach in FIG. 1, in step 12, comprises provision of a hologram film.

The stiff material may be a sheet having a thickness between 0.5 and 5 mm, for example about 2 mm. Materials for the stiffening material may be particular polyvinylchloride (PVC) types, COC, crosslinked epoxy resins or polyester resins (PA6-3-T), polycarbonate, polyetherimide, polyether sulfone, PET with nucleation additives, acrylic glass (PMMA), polysulfone, polystyrene or a styrene-acrylonitrile copolymer. The bond between hologram film and stiffening material may be executed with a corresponding adhesive, especially what is called an OCA (optically clear adhesive). The polymers used for the stiffening material may especially be amorphous polymers, since, in the case of semicrystalline polymers, heating in the autoclave could increase crystallinity, which could lead to an increase in haze. This may be partly prevented by nucleation additives.

In embodiments, the stiffening material is preferably thermoplastic or has a softening point, but no melting point, in the region of the intended process temperatures for the production of the composite glasses. In other words, the stiffening material is softened, but does not melt, in the abovementioned autoclave process for example, and can thus stabilize the hologram film by virtue of the process. The adhesive (OCA) is preferably also chosen such that it remains fully transparent and retains its bonding properties at the process temperatures.

The hologram component thus produced in steps 12 and 13 can then in turn be positioned between two glass panes. By contrast with the first variant of steps 10 and 11, laminant (e.g. PVA and/or EVA) is additionally applied between the hologram component and the glass panes. Then, in step 15, the lamination process is again effected in an autoclave.

FIG. 5 shows an example of a layer stack as after step 14 of the variant via steps 12 and 13. In FIG. 5, a hologram film 21 is disposed on a stiffening material 50. The stiffening material may be configured as described above. The hologram component 51 thus formed is disposed between the already described first glass plate 24 and the second glass plate 26 with the laminant 25 or 22 in between, as likewise already described.

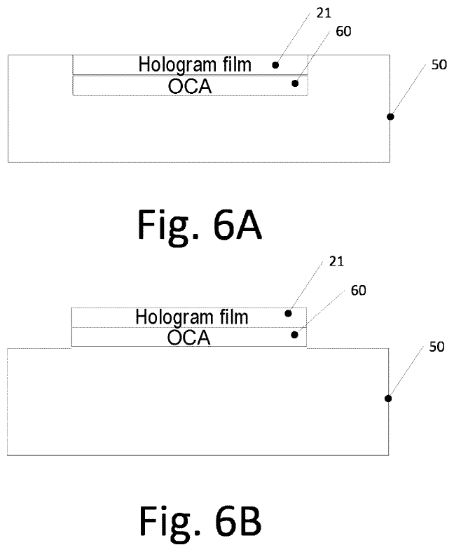

While, in FIG. 5, the stiffening material 50 is disposed on one side of the hologram film 21, the hologram film 21 in other embodiments may also be disposed between two sheets of stiffening material. In addition, the hologram film 21 may be bonded to or sunk into the stiffening material 50, as elucidated in FIGS. 6A and 6B. In FIG. 6A, the hologram film 21 is secured in a recess in the stiffening material 50 by means of OCA 60, while, in FIG. 6B, the hologram film 21 is bonded to the stiffening material 50 by means of the OCA 60. In both cases, a second stiffening material 50 may be mounted on the hologram film, for example by means of a further OCA layer.

It should be noted that, while the production of composite glasses having two glass panes has been described above, it is also possible to produce composite glasses having more than two glass panes, in which case, for example, the lamination component or hologram component may be disposed between two of the glass panes as described, or else multiple lamination components or hologram components may be disposed between different glass panes, and other glass panes may be laminated in a conventional manner.

1. A method of producing a lamination component for bonding of two glass panes comprising:
providing a laminant, and
bonding the laminant to a holographic material.

2. The method as claimed in claim 1, wherein the laminant comprises polyvinylbutyral, ethylene-vinyl acetate or a copolymer thereof.

3. The method as claimed in claim 1, wherein the holographic material comprises a hologram film, and wherein the providing of the laminant and the bonding of the laminant to the holographic material comprises applying the laminant to at least one side of the hologram film.

4. The method as claimed in claim 3, wherein the applying comprises application by extrusion.

5. The method as claimed in claim 3, wherein the laminant is applied to two opposite sides of the hologram film.

6. The method as claimed in claim 5, wherein a thickness of the laminant on a first side of the two opposite sides is at least 1.25 times a thickness of the laminant on a second side of the two opposite sides.

7. The method as claimed in claim 5, wherein thicknesses of the laminant on the two opposite sides are chosen such that, in the production of a composite glass using the laminant, the holographic material is in the neutral fiber of the composite glass.

8. The method as claimed in claim 1, wherein the holographic material comprises a hologram.

9. The method as claimed in claim 1, wherein the bonding of the laminant to the holographic material comprises introducing a photosensitive material into the laminant.

10. The method as claimed in claim 1, wherein the bonding of the laminant to the holographic material comprises producing a multilayer system composed of laminant and photosensitive material.

11. The method as claimed in claim 10, wherein the production comprises a coextrusion.

12. The method as claimed in claim 9, further comprising exposing a hologram into the photosensitive material.

13. The method as claimed in claim 1, wherein the lamination component is produced such that, in the production of a composite glass using the laminant, the holographic material is in the neutral fiber of the composite glass.

14. A method for producing a hologram component comprising:
providing a hologram film, and
bonding the hologram film to a transparent stiffening material having a thickness between 0.5 mm and 5 mm.

15. The method as claimed in claim 14, wherein the transparent stiffening material comprises at least one transparent sheet, wherein the hologram film is mounted on the transparent sheet with an adhesive.

16. The method as claimed in claim 14, wherein the at least one transparent sheet comprises a first transparent sheet and a second transparent sheet, wherein the hologram film is disposed between the first transparent sheet and the second transparent sheet.

17. The method as claimed in claim 14, wherein the hologram component is produced such that, in the production of a composite glass using the laminant, the hologram film is in the neutral fiber of the composite glass.

18. A lamination component for bonding of two glass panes, comprising:
a laminant, and
a holographic material bonded to the laminant.

19. The lamination component as claimed in claim 15,
wherein the lamination component is produced by:
providing a laminant, and
bonding the laminant to a holographic material.

20-29. (canceled)
